(19) United States
(12) Patent Application Publication
(10) Pub. No.: US 2014/0105055 A1
(43) Pub. Date: Apr. 17, 2014

(54) METHOD AND APPARATUS FOR TRANSMITTING CHANNEL STATE INFORMATION IN MULTI-NODE SYSTEM

(71) Applicant: LG ELECTRONICS INC., Seoul (KR)

(72) Inventors: Ji Won Kang, Anyang-si (KR); Jin Young Chun, Anyang-si (KR); Ki Tae Kim, Anyang-si (KR); Su Nam Kim, Anyang-si (KR); Bin Chul Ihm, Anyang-si (KR); Sung Ho Park, Anyang-si (KR)

(73) Assignee: LG ELECTRONICS INC., Seoul (KR)

(21) Appl. No.: 14/124,089

(22) PCT Filed: Jun. 8, 2012
(86) PCT No.: PCT/KR2012/004517

§ 371 Date: Dec. 5, 2013

Related U.S. Application Data
(60) Provisional application No. 61/495,395, filed on Jun. 10, 2011.

(51) Int. Cl. H04W 24/02; H04W 72/04; H04W 24/10

(52) U.S. Cl. CPC H04W 24/02; H04W 24/10; H04W 72/0413
USPC 370/252

(57) ABSTRACT

The present invention provides a method and apparatus in which user equipment sends channel state information. The method includes receiving mapping information informing an uplink (UL) channel mapped to a reference signal; determining a valid downlink (DL) subframe based on the mapping information; measuring the reference signal in the valid DL subframe; and transmitting Channel State Information (CSI), generated based on the measurement, in a configured UL subframe, wherein the UL channel is placed in the configured UL subframe, and the valid DL subframe is a DL subframe including the reference signal mapped to the UL channel.

### TECHNICAL FIELD

The present invention relates to wireless communication and, more particularly, to a method and apparatus in which user equipment transmits channel state information in a multi-node system.

### BACKGROUND ART

The data transfer rate over a wireless communication network is recently rapidly increasing. This is because a variety of devices, such as smart phones and tablet PCs which require Machine-to-Machine (M2M) communication and a high data transfer rate, are appearing and spread. In order to meet a higher data transfer rate, carrier aggregation technology and cognitive radio technology for efficiently using more frequency bands and multiple antenna technology and multiple base station cooperation technology for increasing the data capacity within a limited frequency are recently are highlighted.

Furthermore, a wireless communication network is evolving toward a tendency that the density of accessible nodes around a user is increasing. Here, the term ‘node’ may mean antennas or a group of antennas which are spaced apart from one another in a Distributed Antenna System (DAS). However, the node is not limited to the meaning, but may be used as a broader meaning. That is, the node may become a pico eNB (PeNB), a home eNB (HeNB), a Remote Radio Head (RRH), a Remote Radio Unit (RRU), or a relay. A wireless communication system including nodes having a high density may have higher system performance through cooperation between nodes. That is, if the transmission and reception of each node are managed by one control station so that the nodes are operated as antennas or a group of antennas for one cell, the node may have much more excellent system performance as compared with when the nodes do not cooperate with each other and thus each node operated as an independent Base Station (BS) (or an Advanced BS (ABS), a Node-B (NB), an eNode-B (eNB), or an Access Point (AP)). A wireless communication system including a plurality of nodes is hereinafter referred to as a multi-node system.

In a multi-node system, a node that sends a signal to UE may be different for each UE, and a plurality of nodes may be configured. Here, each node may send a different reference signal. In this case, UE may measure a channel state between the UE and each of the nodes using a plurality of reference signals and feed Information (CSI) periodically or aperiodically.

A periodic CSI feedback is performed by using periodicity semi-statically configured through a higher layer signal and a subframe offset value. An aperiodic CSI feedback is performed in such a manner that, when a BS includes a triggering signal in an UL grant and sends the UL grant to UE, the UE sends CSI through an UL data channel scheduled in response to the UL grant.

In conventional periodic/aperiodic CSI feedbacks, UE measures the reference signal of one subframe determined according to a specification and generates CSI based on the measurement. A resource region, that is, the subject of measurement for generating CSI is called reference resources. For example, a resource region, that is, the subject of measurement for generating a Channel Quality Indicator (CQI) may be called CQI reference resources.

In a multi-node system, however, UE may be requested to measure a reference signal placed in a plurality of subframes and feed back CSI based on the measurement. In this case, it is difficult to precisely specify reference resources according to conventional definitions of reference resources.

### SUMMARY OF INVENTION

### Technical Problem

The present invention provides a method and apparatus for transmitting channel state information in a multi-node system.

### Solution to Problem

In an aspect, a method of user equipment transmitting channel state information is provided. The method comprising: receiving mapping information informing an uplink (UL) channel mapped to a reference signal; determining a valid downlink (DL) subframe based on the mapping information; measuring the reference signal in the valid DL subframe; and sending Channel State Information (CSI), generated based on the measurement, in a configured UL subframe, wherein the UL channel is placed in the configured UL subframe, and

the valid DL subframe is a DL subframe including the reference signal mapped to the UL channel.

The UL channel may be a Physical Uplink Control CHannel (PUCCH) or a Physical Uplink Shared CHannel (PUSCH).

The CSI may be periodically transmitted when the UL channel is the PUCCH.

The CSI may be aperiodically transmitted when the UL channel is the PUSCH.

The reference signal may include a plurality of reference signals placed in a plurality of DL subframes.

The configured UL subframe may include a plurality of UL subframes having different subframe offset values with respect to each of the plurality of DL subframes.

The configured UL subframe may be one UL subframe for the plurality of DL subframes.

In another aspect, a method of user equipment transmitting channel state information is provided. The method comprising: receiving information about a number N of valid downlink (DL) subframes forming Channel State Information (CSI) reference resources; determining N valid DL subframes based on the information about the number N; measuring a reference signal in the N valid DL subframes; and sending CSI, generated based on the measurement, in a configured uplink (UL) subframe, wherein the N valid DL subframes are DL subframes on which a reference signal that is a subject of measurement most recently based on the configured UL subframe is received.

The information about the number N may be received Downlink Control Information (DCI) or a Radio Resource Control (RRC) message.

The number N may be equal to a number of DL subframes including reference signals needed to be measured by the user equipment.

In still another aspect, User equipment (UE) is provided. The UE comprises: a Radio Frequency (RF) unit configured to transmit and receive radio signals; and a processor coupled to the RF unit, wherein the processor receives mapping information informing an uplink (UL) channel mapped to a reference signal, determines a valid downlink (DL) subframe based on the mapping information, measures the reference signal in the valid DL subframe, and sends Channel State Information (CSI), generated based on the measurement, in a configured UL subframe, the UL channel is placed in the configured UL subframe, and the valid DL subframe is a DL subframe including the reference signal mapped to the UL channel.

In still another aspect, User equipment (UE) is provided. The UE comprises: a Radio Frequency (RF) unit configured to transmit and receive radio signals; and a processor coupled to the RF unit, wherein the processor receives information about a number N of valid downlink (DL) subframes forming Channel State Information (CSI) reference resources, determines N valid DL subframes based on the information about the number N, measures a reference signal in the N valid DL subframes, and sends CSI, generated based on the measurement, in a configured uplink (UL) subframe, wherein the N valid DL subframes are DL subframes on which a reference signal that is a subject of measurement most recently based on the configured UL subframe is received.

### Advantageous Effects of Invention

In a multi-node system, each node may send a different reference signal and a plurality of nodes may be allocated to a single UE. In this case, UE may have to measure a plurality of reference signals and feed back periodic/aperiodic CSI. In accordance with the present invention, reference resources may be precisely specified. Accordingly, a more accurate CSI feedback is possible, and consequently system performance is improved.

### BRIEF DESCRIPTION OF DRAWINGS

FIG. 1 shows an example of a multi-node system.

FIG. 2 shows the structure of a Frequency Division Duplex (FDD) radio frame in 3GPP LTE.

FIG. 3 shows a Time Division Duplex (TDD) radio frame structure in 3GPP LTE.

FIG. 4 illustrates a resource grid for one DL slot.

FIG. 5 shows an example of a DL subframe structure.

FIG. 6 shows the structure of a UL subframe.

FIG. 7 shows an example in which a resource index is mapped to physical resources.

FIG. 8 shows the mapping of a CRS in a normal cyclic prefix (CP).

FIG. 9 shows the mapping of a CSI-RS to a CSI-RS configuration 0 in a normal CP.

FIG. 10 illustrates a plurality of CSI-RSs that have to be measured by one UE.

FIG. 11 shows an example in which a plurality of CSI-RSs transmitted in the same subframe is configured for the same UE.

FIG. 12 illustrates a first embodiment of a periodic CSI transmission method performed by UE.

FIG. 13 illustrates a second embodiment of a periodic CSI transmission method performed by UE.

FIG. 14 shows an example of a CSI feedback method performed by UE when the first example of a definition of CQI reference resources is used.

FIG. 15 shows a third embodiment of a periodic CSI transmission method performed by UE.

FIG. 16 shows an example of a CSI feedback method performed by UE when the second example of a definition of CQI reference resources is used.

FIG. 17 shows a first embodiment of an aperiodic CSI transmission method performed by UE.

FIG. 18 shows a second embodiment of an aperiodic CSI transmission method performed by UE.

FIG. 19 shows a third embodiment of an aperiodic CSI transmission method performed by UE.

FIG. 20 is a block diagram showing a BS and UE.

### MODE FOR THE INVENTION

The following technologies may be used in a variety of multiple access schemes, such as Code Division Multiple Access (CDMA), Frequency Division Multiple Access (FDMA), Time Division Multiple Access (TDMA), Orthogonal Frequency Division Multiple Access (OFDMA), and Single Carrier Frequency Division Multiple Access (SC-FDMA). CDMA may be implemented using radio technology, such as Universal Terrestrial Radio Access (UTRA) or CDMA2000. TDMA may be implemented using radio technology, such as Global System for communications (GSM)/General Packet Radio Service (GPRS)/Enhanced Data Rates for GSM Evolution (EDGE). OFDMA may be implemented using radio technology, such as and Electronics Engineers (IEEE) 802.11 (Wi-Fi), IEEE 802.16 (WiMAX), IEEE 802.20, or Evolved UTRA (E-UTRA). IEEE 802.16m is an evolution of IEEE 802.16e, and it provides backward compatibility with systems based on IEEE 802.16e. UTRA is part of a Universal Mobile Telecommunications System (UMTS). 3^{rd} Generation Partnership Project (3GPP) Long Term Evolution (LTE) is part of an Evolved UMTS (E-UMTS) using E-UTRA, and it adopts OFDMA in downlink and adopts SC-FDMA in uplink. LTE-Advanced (LTE-A) is the evolution of LTE.

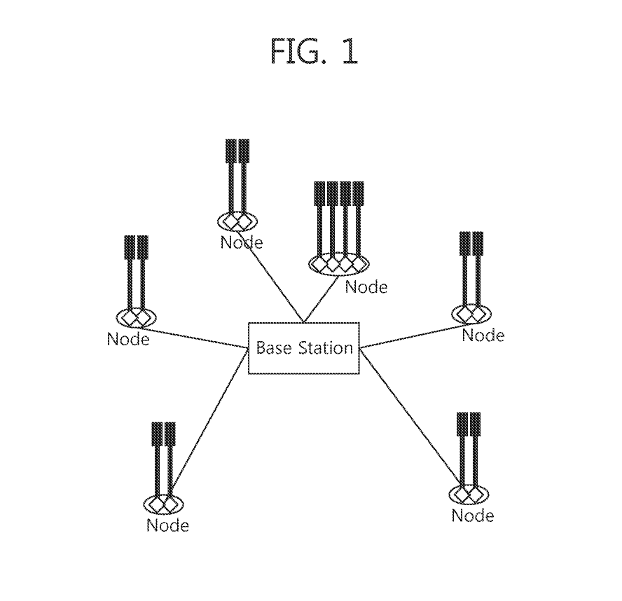

FIG. 1 shows an example of a multi-node system.

Referring to FIG. 1, the multi-node system includes a BS and a plurality of nodes.

In FIG. 1, the node may mean a macro eNB, a pico BS (PeNB), a home eNB (HeNB), a Remote Radio Head (RRH), a relay, or a distributed antenna. The node is also called a point.

In a multi-node system, if the transmission and reception of all nodes are managed by one BS controller and thus each of the nodes is operated as one cell, this system may be considered as a Distributed Antenna System (DAS) which forms one cell. In a DAS, each node may be assigned each node ID or the nodes may be operated as a set of some antennas within a cell without individual node IDs. In other words, a DAS refers to a system in which antennas (i.e., nodes) are distributed and placed at various positions within a cell and the antennas are managed by a BS. The DAS differs from a conventional centralized antenna system (CAS) in which the antennas of a BS are concentrated on the center of a cell and disposed.

In a multi-node system, if each node has each cell ID and performs scheduling and handover, it may be considered as a multi-cell (e.g., a macro cell/femto cell/pico cell) system. If the multi-cells are configured in an overlapping manner according to the coverage, this is called a multi-tier network.

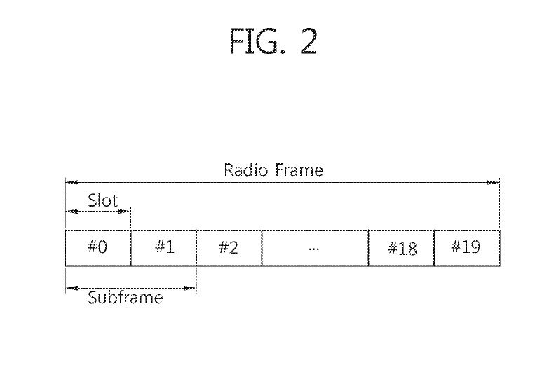

FIG. 2 shows the structure of a Frequency Division Duplex (FDD) radio frame in 3GPP LTE. This radio frame structure is called a frame structure type 1.

Referring to FIG. 2, the FDD radio frame includes 10 subframes, and one subframe is defined by two consecutive slots. The time taken for one subframe to be transmitted is called a Transmission Time Interval (TTI). The time length of a radio frame T_{f}=307200*Tₛ=10 ms and consists of 20 slots. The time length of one slot Tₛₗₒₜ=15360*Tₛ=0.5 ms, and the slots are numbered 0 to 19. Downlink (DL) in which each node or BS sends a signal to UE and uplink (UL) in which UE sends a signal to each node or BS are divided in the frequency region.

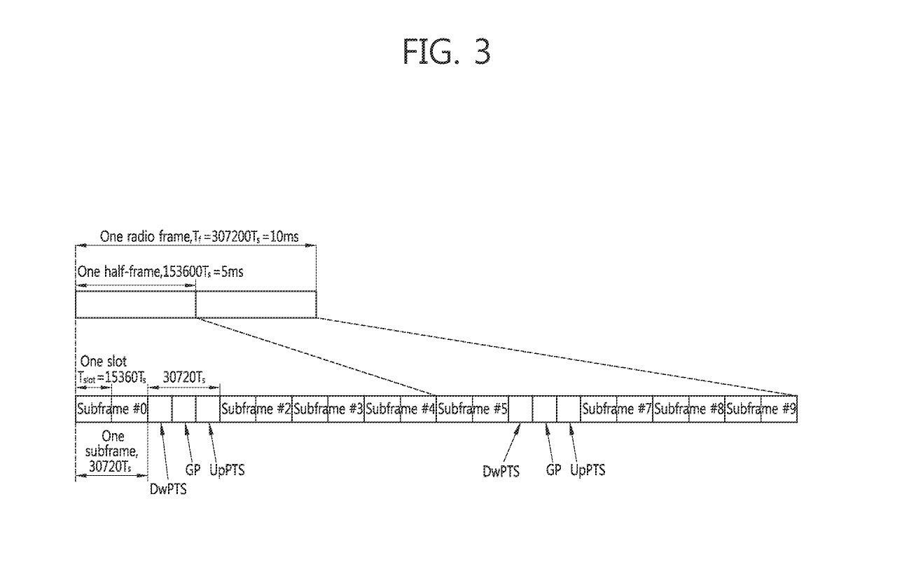

FIG. 3 shows a Time Division Duplex (TDD) radio frame structure in 3GPP LTE. This radio frame structure is called a frame structure type 2.

Referring to FIG. 3, the TDD radio frame has a length of 10 ms and consists of two half-frame each having a length of 5 ms. Furthermore, one half-frame consists of 5 subframes each having a length of 1 ms. One subframe is designated as one of a UL subframe, a DL subframe, and a special subframe. One radio frame includes at least one UL subframe and at least one DL subframe. One subframe is defined by two consecutive slots. For example, the length of one subframe may be 1 ms, and the length of one slot may be 0.5 ms.

The special subframe is a specific period for separating UL and DL from each other between a UL subframe and a DL subframe. One radio frame includes at least one special subframe. The special subframe includes a Downlink Pilot Time Slot (DwPTS), a guard period, and an Uplink Pilot Time Slot (UpPTS). The DwPTS is used for initial cell search, synchronization, or channel estimation. The UpPTS is used for channel estimation in a BS and UL transmission synchronization of UE. The guard period is a period where interference occurring in UL owing to the multi-path delay of a DL signal is removed between UL and DL.

In the FDD and TDD radio frames, one slot includes a plurality of Orthogonal Frequency Division Multiplexing (OFDM) symbols in the time domain and includes a plurality of Resource Blocks (RBs) in the frequency domain. The OFDM symbol is for representing one symbol period because 3GPP LTE uses OFDMA in DL and may be called another term, such as an SC-FDMA symbol, according to a multiple access scheme. An RB is a unit of resource allocation and includes a plurality of contiguous subcarriers in one slot.

The structure of the radio frame is only illustrative, and the number of subframes included in the radio frame, the number of slots included in the subframe, and the number of OFDM symbols included in the slot may be changed in various ways.

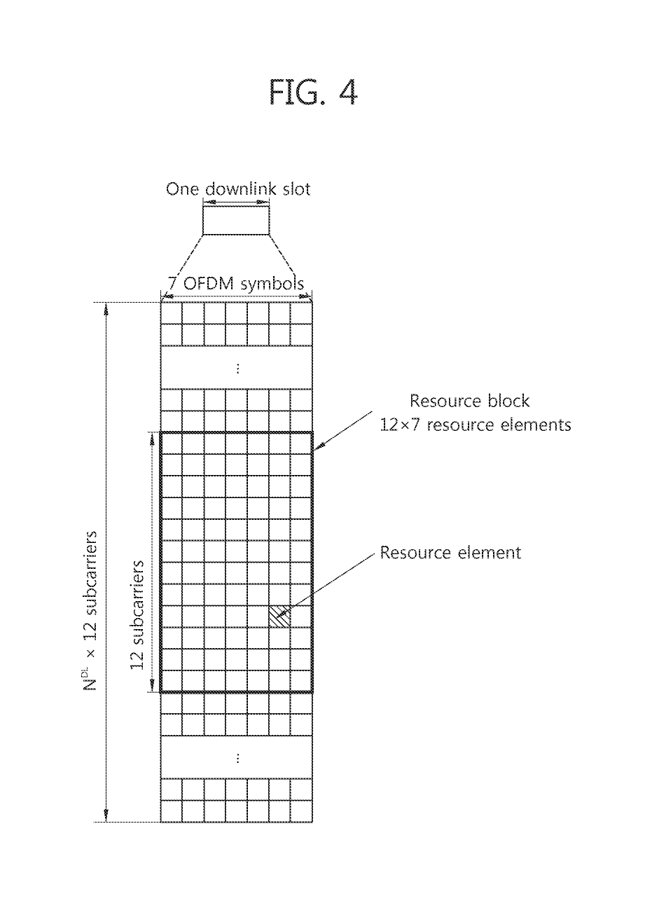

FIG. 4 illustrates a resource grid for one DL slot.

Referring to FIG. 4, one DL slot includes a plurality of OFDM symbols in the time domain. Here, one DL slot is illustrated as including 7 OFDMA symbols, and one RB is illustrated as including 12 subcarriers in the frequency domain, but not limited thereto.

Each element on the resource grid is called a resource element, and one RB includes 12×7 resource elements. The number N^{DL} of RBs included in a DL slot depends on a DL transmission bandwidth configuration in a cell. The resource grid for the DL slot may also be applied to an UL slot.

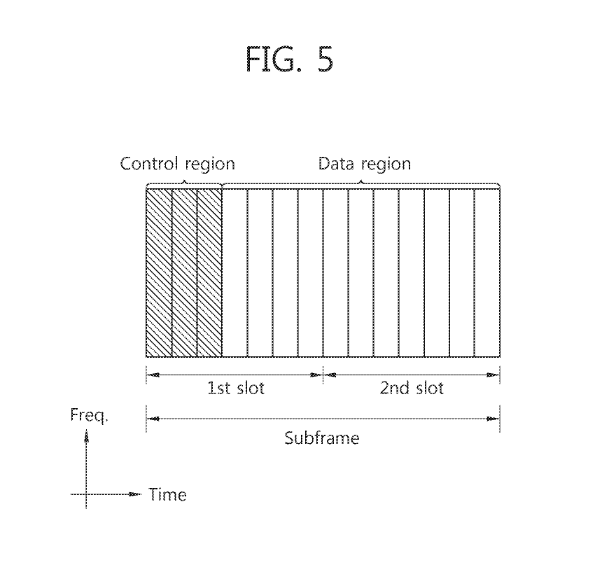

FIG. 5 shows an example of a DL subframe structure.

Referring to FIG. 5, the subframe includes two contiguous slots. A maximum of the former 3 OFDM symbols in the first slot of the subframe may correspond to a control region to which DL control channels are allocated, and the remaining OFDM symbols may correspond to a data region to which Physical Downlink Shared Channels (PDSCHs) are allocated.

The DL control channel includes a Physical Control Format Indicator Channel (PCFICH), a Physical Downlink Control Channel (PDCCH), a Physical Hybrid-ARQ Indicator Channel (PHICH), etc. A PCFICH transmitted in the first OFDM symbol of a subframe carries information about the number of OFDM symbols (i.e., the size of a control region) used to transmit control channels within the subframe. Control information transmitted through the PDCCH is called Downlink Control Information (DCI). DCI comprises UL resource allocation information, DL resource allocation information, a UL transmit power control command for specific UE groups, etc. DCI has various formats. A DCI format 0 is used for PUSCH scheduling. DCI format used for PUSCH scheduling can be called uplink DCI format.

Information (field) transmitted through the DCI format 0 is as follows.

1) A flag for distinguishing the DCI format 0 and a DCI format 1A (if the flag is 0, it indicates the DCI format 0, and if the flag is 1, it indicates the DCI format 1A), 2) A hopping flag (1 bit), 3) RB designation and hopping resource allocation, 4) A modulation and coding scheme and redundancy version (5 bits), 5) A new data indicator (1 bit), 6) A TPC command (2 bits) for a scheduled PUSCH, 7) A cyclic shift (3 bits) for a DM-RS, 8) An UL index, 9) a DL designation index (only in TDD), 10) A CQI request, etc. If the number of information bits in the DCI format 0 is smaller than the payload size of the DCI format 1A, ‘0’ is padded so that the DCI format 1A is identical with the payload size.

A DCI format 1 is used for one PDSCH codeword scheduling. The DCI format 1A is used for the compact scheduling of one PDSCH codeword or a random access process. A DCI format 1B includes precoding information, and it is used for compact scheduling for one PDSCH codeword. A DCI format 1C is used for very compact scheduling for one PDSCH codeword. A DCI format 1D includes precoding and power offset information, and it is used for compact scheduling for one PDSCH codeword. A DCI format 2 is used for PDSCH designation for a closed-loop MIMO operation. A DCI format 2A is used for PDSCH designation for an open-loop MIMO operation. A DCI format 3 is used to transmit a TPC command for a PUCCH and a PUSCH through power adjustment of 2 bits. A DCI format 3A is used to transmit a TPC command for a PUCCH and a PUSCH through power adjustment of 1 bit.

A PHICH carries an Acknowledgement (ACK)/Not-Acknowledgement (NACK) signal for the Hybrid Automatic Repeat Request (HARQ) of UL data. That is, an ACK/NACK signal for UL data transmitted by UE is transmitted by a BS on a PHICH.

A PDSCH is a channel on which control information and/or data is transmitted. UE may read data transmitted through a PDSCH by decoding control information transmitted through a PDCCH.

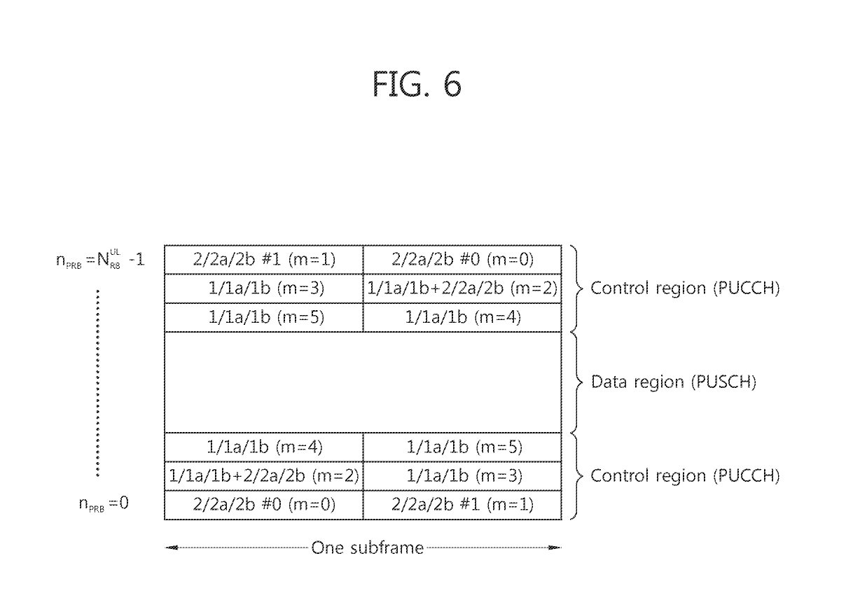

FIG. 6 shows the structure of a UL subframe.

The UL subframe may be divided into a control region and a data region in the frequency domain. A Physical Uplink Control Channel (PUCCH) on which Uplink Control Information (UCI) is transmitted is allocated to the control region. A Physical Uplink Shared Channel (PUSCH) on which UL data and/or UL control information is transmitted is allocated to the data region. In this meaning, the control region may be called a PUCCH region, and the data region may be called a PUSCH region. UE may support the simultaneous transmission of a PUSCH and a PUCCH or may not support the simultaneous transmission of a PUSCH and a PUCCH according to configuration information indicated by a higher layer.

A PUSCH is mapped to an Uplink Shared Channel (UL-SCH), that is, a transport channel. UL data transmitted on the PUSCH may be a transport block, that is, a data block for an UL-SCH transmitted for a TTI. The transport block may be user information. Alternatively, the UL data may be multiplexed data. The multiplexed data may include a transport block and UL control information for an UL-SCH which are multiplexed. For example, UL control information multiplexed with UL data may include a Channel Quality Indicator (CQI), a Precoding Matrix Indicator (PMI), a Hybrid Automatic Repeat request (HARQ), acknowledgement/not-acknowledgement (ACK/NACK), a Rank Indicator (RI), a Precoding Type Indication (PTI), and so on. What UL control information, together with UL data, is transmitted in the data region as described above is called the piggyback transmission of UCI. Only UL control information may be transmitted in a PUSCH.

A PUCCH for one UE is allocated as a Resource Block (RB) pair in a subframe. Resource blocks belonging to a RB pair occupy different subcarriers in a first slot and a second slot. A frequency occupied by a resource block belonging to an RB pair allocated to a PUCCH is changed on the basis of a slot boundary. This is called that the frequency of the RB pair allocated to the PUCCH has been frequency-hopped at the boundary of a slot. A frequency diversity gain may be obtained when UE sends UL control information through different subcarriers according to a lapse of time.

A PUCCH carries various types of control information according to a format. A PUCCH format 1 carries a Scheduling Request (SR). Here, an On-Off Keying (OOK) scheme may be used. A PUCCH format 1a carries an Acknowledgement/Non-Acknowledgement (ACK/NACK) modulated according to a Binary Phase Shift Keying (BPSK) scheme for one codeword. A PUCCH format 1b carries ACK/NACK modulated according to a Quadrature Phase Shift Keying (QPSK) scheme for two codewords. A PUCCH format 2 carries a Channel Quality Indicator (CQI) modulated according to a QPSK scheme. PUCCH formats 2a and 2b carry a CQI and ACK/NACK. A PUCCH format 3 is modulated according to a QPSK scheme, and it may carry a plurality of ACK/NACK and SRs.

Each PUCCH format is mapped to a PUCCH region and transmitted. For example, the PUCCH formats 2/2a/2b may be mapped to the RB (in FIG. 6, m=0,1) of the edge of a band allocated to UE and then transmitted. A mixed PUCCH RB may be mapped to an RB (e.g., m=2) adjacent in the direction of the center of the band in the RB to which the PUCCH formats 2/2a/2b are allocated and then transmitted. The PUCCH formats 1/1a/1b on which an SR and ACK/NACK are transmitted may be disposed in an RB having m=4 or m=5. UE may be informed of the number N⁽²⁾_{RB} of RBs that may be used in the PUCCH formats 2/2a/2b on which a CQI may be transmitted through a broadcasted signal.

All PUCCH formats use the Cyclic Shift (CS) of a sequence in each OFDM symbol. The CS sequence is generated by cyclically shifting a base sequence by a specific CS amount. The specific CS amount is indicated by a CS index.

An example in which the base sequence rᵤ(n) is defined is as follows.

rᵤ(n)=e^{jb(n)π/4} [Equation 1]

In Equation 1, u is a root index, n is an element index, 0≦n≦N−1, and N is the length of the base sequence. b(n) is defined in section 5.5 of 3GPP TS 36.211 V8.7.0.

The length of the sequence is equal to the number of elements included in the sequence. u may be defined by a cell identifier (ID), a slot number within a radio frame, etc. Assuming that a base sequence is mapped to one resource block within the frequency domain, the length N of the base sequence is 12 because one resource block includes 12 subcarriers. A different base sequence is defined according to a different root index.

A cyclic-shifted sequence r(n, I_{cs}) may be generated by cyclically shifting the base sequence r(n) as in Equation 2 below.

$$r ( n , {I}_{cs} ) = r ( n ) \cdot exp ( \frac{j2π {I}_{cs} n}{N} ) , 0 \leq {I}_{cs} \leq N - 1 \qquad [ Equation 2 ]$$

In Equation 2, I_{cs} is a CS index indicating a CS amount (0≦I_{cs}≦N−1).

Available CS indices of the base sequence refer to a CS index that may be derived from the base sequence according to a CS interval. For example, if the length of a base sequence is 12 and a CS interval is 1, a total number of available CS indices of the base sequence is 12. In contrast, if the length of a base sequence is 12 and a CS interval is 2, a total number of available CS indices of the base sequence is 6. The orthogonal sequence index i, the CS index I_{cs}, and the resource block index m are parameters necessary to configure a PUCCH and are resources used to distinguish PUCCHs (or UEs) from each other.

In 3GPP LTE, in order for UE to obtain 3 parameters for configuring a PUCCH, resource indices (also called a PUCCH resource index) n⁽¹⁾_{PUCCH} n⁽²⁾_{PUCCH} are defined. Here, n⁽¹⁾_{PUCCH} is a resource index for the PUCCH formats 1/1a/1b, and n⁽²⁾_{PUCCH} is a resource index for the PUCCH formats 2/2a/2b. A resource index n⁽¹⁾_{PUCCH}=n_{CCE}+N⁽¹⁾_{PUCCH}, and n_{CCE} is the number of a first CCE which is used to transmit a relevant DCI (i.e., the index of a first CCE which is used for relevant PDCCH), and N⁽¹⁾_{PUCCH} is a parameter that a BS informs UE the parameter through a high layer message. Detailed contents are as follows.

```
SPS(semi-persistent scheduled)-UE: defined by RRC
Scheduling request: defined by RRC
Otherwise: n_{PUCCH}⁽¹⁾ = n_{CCE} + N_{PUCCH}⁽¹⁾ (refer TS36.213 subclause
10.1[2])
  n_{CCE}: First CCE (control channel elements) index of PDCCH
  N_{PUCCH}⁽¹⁾ = c · N_{sc}^{RB}/Δ_{shift}^{PUCCH}
  $c - \{ \begin{matrix}3 & normal cyclic prefix \\ 2 & extended cyclic prefix\end{matrix}$
  N_{sc}^{RB} − 12
  Δ_{shift}^{PUCCH} ∈ {1,2,3}
```

n⁽²⁾_{PUCCH} is given a UE-specific way and is semi-statically configured by a higher layer signal, such as RRC. In LTE, n⁽²⁾_{PUCCH} is included in an RRC message called ‘CQI-ReportConfig’.

UE determines an orthogonal sequence index, a CS index, etc. using the resource indices n⁽¹⁾_{PUCCH}, n⁽²⁾_{PUCCH}.

UE transmits a PUCCH using physical resources mapped to a resource index.

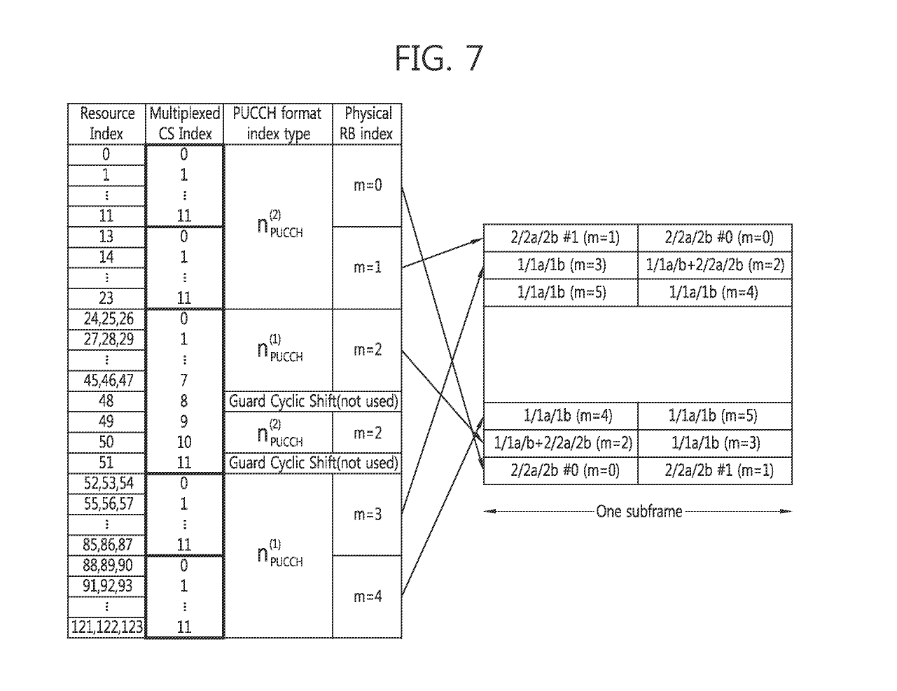

FIG. 7 shows an example in which a resource index is mapped to physical resources.

UE calculates a resource block index m based on a resource index, allocates physical resources according to a PUCCH format, and transmit the PUCCH. The following relationship exists between a resource index allocated to each UE and a mapped physical resource block.

System Parameters

| | |
|---|---|
| Δ_{shift}^{PUCCH} = 1 | → 12 (available cyclic |
| | shift value) |
| c = 3 | → Normal CP |
| N_{PUCCH}⁽¹⁾ = c · N_{sc}^{RB}/Δ_{shift}^{PUCCH} = 36 | |
| N_{RB}⁽²⁾ = 2 · N_{sc}^{RB} = 24 | → Bandwidth |
| | available for use by PUCCH |
| | formats 2/2a/2b (expressed in |
| | multiple of N_{sc}^{RB}) |
| N_{cs}⁽¹⁾ = 7 | → Number of cyclic shifts used |
| | for PUCCH formats 1/1a/1b in a |
| | resource block with a mix of |
| | formats 1/1a/1b and 2/2a/2b |

In a multi-node system, a different reference signal may be transmitted from each node or each node group. First, a reference signal is described.

In LTE Rel-8, for channel measurement and channel estimation for a PDSCH, a Cell-specific Reference Signal (CRS) is used.

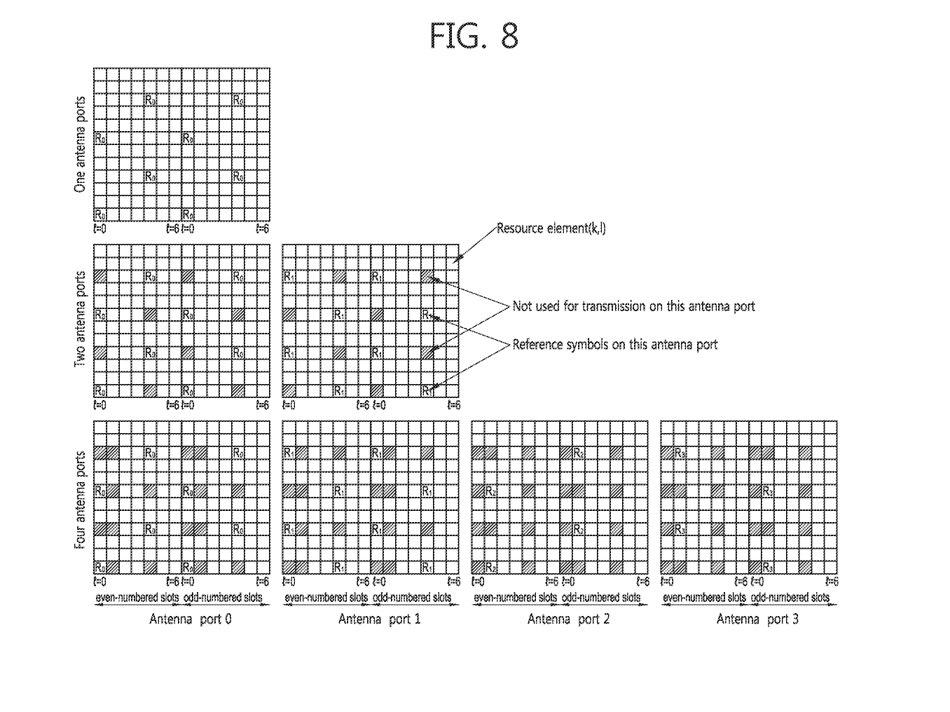

FIG. 8 shows the mapping of a CRS in a normal cyclic prefix (CP).

Referring to FIG. 8, in case of multiple antenna transmission using a plurality of antennas, a resource grid exists in each antenna, and at least one reference signal for an antenna may be mapped to each resource grid. A reference signal for each antenna includes reference symbols. In FIG. 8, Rp indicates the reference symbol of an antenna port p (pε{0, 1, 2, 3}). R0 to R3 are not mapped to overlapping resource elements.

In one OFDM symbol, each Rp may be placed at 6 subcarrier intervals. The number of R0s and the number of R1s within a subframe are identical with each other, and the number of R2s and the number of R3s within a subframe are identical with each other. The number of R2s or R3s within a subframe is smaller than the number of R0s or R1s within the subframe. Rp is not used for any transmission through other antennas other than a No. p antenna.

In LTE-A, for channel measurement and channel estimation for a PDSCH, a Channel Status Information Reference Signal (CSI-RS) may be used separately from a CRS. The CSI-RS is described below.

A CSI-RS, unlike a CRS, includes a maximum of 32 different configurations in order to reduce Inter-Cell Interference (ICI) in a multi-cell environment including heterogeneous network environments.

A configuration for the CSI-RS is different according to the number of antenna ports within a cell and is given so that maximum different configurations between adjacent cells are configured. The CSI-RS is divided according to a CP type. The configuration for the CSI-RS is divided into a configuration applied to both a frame structure type 1 and a frame structure type 2 and a configuration applied to only the frame structure type 2 according to a frame structure type (the frame structure type 1 is FDD, and the frame structure type 2 is TDD).

The CSI-RS, unlike the CRS, supports a maximum of 8 antenna ports, and an antenna port p is supported by {15}, {15, 16}, {15,16,17,18}, {15, . . . , 22}. That is, the CSI-RS supports 1, 2, 4, or 8 antenna ports. An interval Δf between subcarriers is defined only for 15 kHz.

A sequence r_{l,ns}(m) for the CSI-RS is generated as in Equation below.

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {N}_{RB}^{max , DL} - 1 \\ where , \\ {c}_{init} = {2}^{10} \cdot ( 7 \cdot ( {n}_{s} + 1 ) + l + 1 ) \cdot ( 2 \cdot {N}_{ID}^{cc 11} + 1 ) + 2 \cdot {N}_{ID}^{cc 11} + {N}_{CP} \\ {N}_{CP} = \{ \begin{matrix}1 & for normal C P \\ 0 & for extended C P\end{matrix} \qquad [ Equation 3 ]$$

In Equation 3, nₛ is a slot number within a radio frame, and 1 is an OFDM symbol number within the slot. c(i) is a pseudo random sequence and is started from each OFDM symbol as cᵢₙᵢₜ. N_{ID}^{cell} indicates a physical layer cell ID.

In subframes configured to transmit a CSI-RS, a reference signal sequence r_{l,ns}(m) is mapped to a complex value modulation symbol ado used as a reference symbol for an antenna port p.

A relationship between r_{l,ns}(m) and a_{k,l}^{(p)} is defined as in Equation below.

$$[ Equation 4 ]$$

$${a}_{k , l}^{( p )} = {w}_{{l}^{″}} \cdot {r}_{l , {n}_{s}} ( {m}^{′} ) \\ where \\ k = {k}^{′} + 12 m + \{ \begin{matrix}- 0 & for p ∈ \{ 15 , 16 \} , normal cyclic prefix \\ - 6 & for p ∈ \{ 17 , 18 \} , normal cyclic prefix \\ - 1 & for p ∈ \{ 19 , 20 \} , normal cyclic prefix \\ - 7 & for p ∈ \{ 21 , 22 \} , normal cyclic prefix \\ - 0 & for p ∈ \{ 15 , 16 \} , extended cyclic prefix \\ - 3 & for p ∈ \{ 17 , 18 \} , extended cyclic prefix \\ - 6 & for p ∈ \{ 19 , 20 \} , extended cyclic prefix \\ - 9 & for p ∈ \{ 21 , 22 \} , extended cyclic prefix\end{matrix} \\ l = {l}^{′} + \{ \begin{matrix}{l}^{″} & C S I reference signal configurations 0 \text{-} 19 , normal cyclic prefix \\ 2 {l}^{″} & C S I reference signal configurations 20 \text{-} 31 , normal cycle prefix \\ {l}^{″} & C S I reference signal configurations 0 \text{-} 27 , extended cyclic prefix\end{matrix} \\ {w}_{{l}^{″}} = \{ \begin{matrix}1 & p ∈ \{ 15 , 17 , 19 , 21 \} \\ {( - 1 )}^{{l}^{″}} & p ∈ \{ 16 , 18 , 20 , 22 \}\end{matrix} \\ {l}^{″} = 0 , 1 \\ m = 0 , 1 , … , {N}_{RB}^{DL} - 1 \\ {m}^{′} = m + ⌊ \frac{{N}_{RB}^{max , DL} - {N}_{RB}^{DL}}{2} ⌋$$

In Equation 4, (k′, l′) and nₛ are given in Table 1 and Table 2 below. A CSI-RS may be transmitted in a DL slot in which (nₛ mod 2) meets the conditions of Table 1 and Table 2 (mod means a modular operation, that is, mod means the remainder obtained by dividing nₛ by 2).

Table below shows a CSI-RS configuration for a normal CP.

TABLE 1

| | | Number of CSI reference | | | | | |
|---|---|---|---|---|---|---|---|
| | CSI reference | signals configured | | | | | |
| | signal | 1 or 2 | | 4 | | 8 | |
| | configuration | (k′, l′) | nₛ mod 2 | (k′, l′) | nₛ mod 2 | (k′, l′) | nₛ mod 2 |
| Frame | 0 | (9, 5) | 0 | (9, 5) | 0 | (9, 5) | 0 |
| structure | 1 | (11, 2) | 1 | (11, 2) | 1 | (11, 2) | 1 |
| type 1 and 2 | 2 | (9, 2) | 1 | (9, 2) | 1 | (9, 2) | 1 |
| | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | 1 | | | | |
| Frame | 20 | (11, 1) | 1 | (11, 1) | 1 | (11, 1) | 1 |
| structure | 21 | (9, 1) | 1 | (9, 1) | 1 | (9, 1) | 1 |
| type 2 only | 22 | (7, 1) | 1 | (7, 1) | 1 | (7, 1) | 1 |
| | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

Table below shows a CSI-RS configuration for an extended CP.

TABLE 2

| | | Number of CSI reference | | | | | |
|---|---|---|---|---|---|---|---|
| | CSI reference | signals configured | | | | | |
| | signal | 1 or 2 | | 4 | | 8 | |
| | configuration | (k′, l′) | nₛ mod 2 | (k′, l′) | nₛ mod 2 | (k′, l′) | nₛ mod 2 |
| Frame structure | 0 | (11, 4) | 0 | (11, 4) | 0 | (11, 4) | 0 |
| type 1 and 2 | 1 | (9, 4) | 0 | (9, 4) | 0 | (9, 4) | 0 |
| | 2 | (10, 4) | 1 | (10, 4) | 1 | (10, 4) | 1 |
| | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| Frame structure | 16 | (11, 1) | 1 | (11, 1) | 1 | (11, 1) | 1 |
| type 2 only | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| | 20 | (4, 1) | 1 | (4, 1) | 1 | | |
| | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

A subframe including a CSI-RS must satisfy Equation below.

(10n_{f}+└nₛ/2┘−Δ_{CSI-RS})mod T_{CSI-RS}=0,

Furthermore, the CSI-RS may be transmitted in a subframe satisfying the condition of Table 3.

Table 3 shows a CSI-RS subframe configuration related to a duty cycle. n_{f} is a system frame number.

TABLE 3

| | CSI-RS | CSI-RS |
|---|---|---|
| CSI-RS- | periodicity T_{CSI-RS} | subframe offset Δ_{CSI-RS} |
| SubframeConfig I_{CSI-RS} | (subframes) | (subframes) |
| 0-4 | 5 | I_{CSI-RS} |
| 5-14 | 10 | I_{CSI-RS}-5 |
| 15-34 | 20 | I_{CSI-RS}-15 |
| 35-74 | 40 | I_{CSI-RS}-35 |
| 75-154 | 80 | I_{CSI-RS}-75 |

In Table 3, ‘CSI-RS-SubframeConfig’, that is, I_{CSI-RS} is a value given by a higher layer, and it indicates a CSI-RS subframe configuration. T_{CSI-RS} indicates a cell-specific subframe configuration period, and Δ_{CSI-RS} indicates a cell-specific subframe offset. A CSI-RS supports five types of duty cycles according to a CQI/CSI feedback, and it may be transmitted with a different subframe offset in each cell.

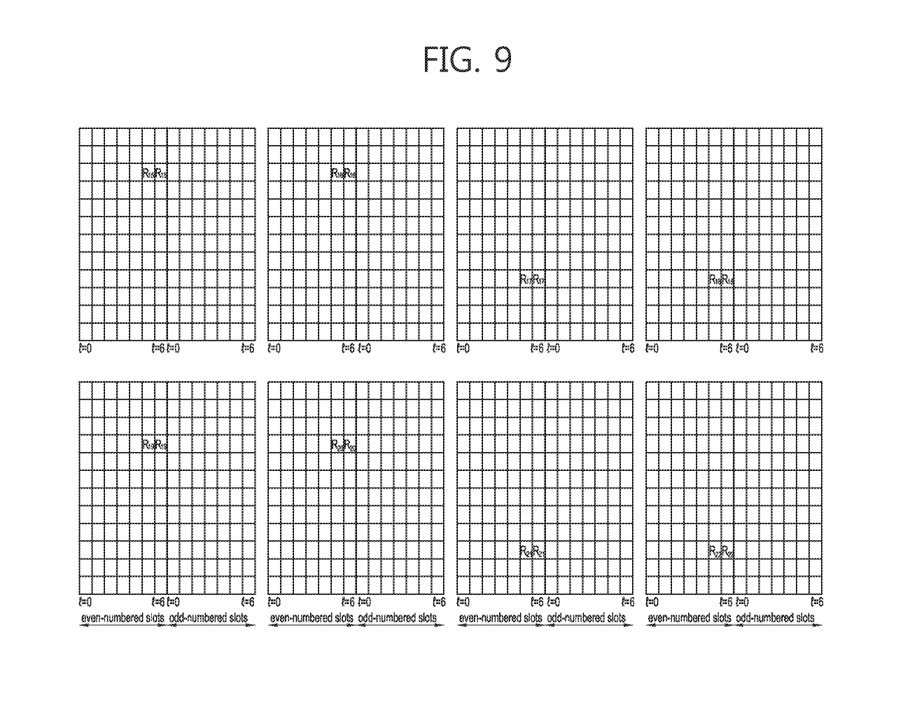

FIG. 9 shows the mapping of a CSI-RS to a CSI-RS configuration 0 in a normal CP.

Referring to FIG. 9, CSI-RSs are transmitted using two same REs that are contiguous to each other for two antenna ports, for example, p={15, 16}, {17, 18}, {19, 20}, {21, 22}, but are transmitted using an Orthogonal Cover Code (OCC). Each of the CSI-RSs is allocated with a specific pattern in a radio resource region according to a CSI-RS configuration. In this sense, the CSI-RS is also called a CSI-RS pattern.

A plurality of CSI-RS configurations can be used in a cell. In this case, one CSI-RS configuration in which UE assumes non-zero transmit power and one or non CSI-RS configuration in which UE assumes zero transmit power may be configured.

A CSI-RS is not transmitted in the following cases.

1. A special subframe of the frame structure type 2

2. When it is collided with a synchronization signal, a physical broadcast channel (PBCH), or a system information block (SIB)

3. A subframe in which a paging message is transmitted

A resource element (k,l) used to transmit a CSI-RS for a specific antenna port of a set S is not used to transmit a PDSCH for a specific antenna port in the same slot. Furthermore, the resource element (k,l) is not used to transmit a CSI-RS for another specific antenna port other than the set S in the same slot. Here, antenna ports included in the set S include {15, 16}, {17,18}, {19,20}, and {21, 22}.

Parameters necessary to transmit the CSI-RS include 1. a CSI-RS port number, 2. CSI-RS configuration information, 3. a CSI-RS subframe configuration I_{CSI-RS}, 4. a subframe configuration periodicity T_{CSI-RS}, 5. a subframe offset Δ_{CSI-RS}, and so on. The parameters are cell-specific and are given through higher layer signaling.

A BS may apply a reference signal, such as a CRS and a CSI-RS, so that UE may identify each node in a multi-node system.

UE may measure the reference signal, generate Channel State Information (CSI), and then report or feed back the CSI to a BS or a node. CSI includes a CQI, a PMI, an RI, etc.

A method of transmitting CSI includes periodic transmission and aperiodic transmission. In the periodic transmission method, CSI may be transmitted through a PUCCH or a PUSCH. The aperiodic transmission method is performed in such a manner that, if more precise CSI is necessary, a BS requests CSI from UE. The aperiodic transmission method is performed through a PUSCH. Since a PUSCH is used, capacity is greater and detailed channel state reporting possible. If periodic transmission and aperiodic transmission collide with each other, only aperiodic transmission is performed.

An aperiodic CSI feedback is performed when there is a request from a BS. If UE is accessed, a BS may request a CSI feedback from the UE when sending a random access response grant to the UE. In some embodiments, a BS may request a CSI feedback from UE by using a DCI format in which UL scheduling information is transmitted. A CSI request field requesting a CSI feedback comprises 1 bit or 2 bits. If the CSI request field is 1 bit, in case of ‘0’, a CSI report is not triggered. In case of ‘1’, a CSI report is triggered. In case of 2 bits, the following Table is applied.

TABLE 4

| VALUE OF CSI | |
|---|---|
| REQUEST FIELD | DESCRIPTION |
| ‘00’ | No aperiodic CSI report is triggered |
| ‘01’ | Aperiodic CSI report triggered for serving cell c |
| ‘10’ | Aperiodic CSI report is triggered for a 1^{st} set of |
| | serving cells configured by higher layers |
| ‘11’ | Aperiodic CSI report is triggered for a 2^{nd} set of |
| | serving cells configured by higher layers |

When a CSI report is triggered by a CSI request field, UE feeds back CSI through PUSCH resources designated in the DCI format 0. Here, what CSI will be fed back is determined according to a reporting mode. For example, which one of a wideband CQI, a UE-selective CQI, and a higher layer configuration CQI will be fed back is determined according to a reporting mode. Furthermore, what kind of a PMI will be fed back is also determined along with a CQI. A PUSCH reporting mode is semi-statically configured through a higher layer message, and an example thereof is listed in Table 5 below.

TABLE 5

| | | PMI Feedback Type | | |
|---|---|---|---|---|
| | | | Single | Multiple |
| | | No PMI | PMI | PMI |
| PUSCH CQI | Wideband | | | Mode 1-2 |
| Feedback Type | (wideband CQI) | | | |
| | UE Selected | Mode 2-0 | | Mode 2-2 |
| | (subband CQI) | | | |
| | Higher Layer- | Mode 3-0 | Mode 3-1 | |
| | configured | | | |
| | (subband CQI) | | | |

Unlike aperiodic CSI feedback transmitted only when it is triggered through a PDCCH, periodic CSI feedback is semi-statically configured through a higher layer message. The periodicity N_{pd} and subframe offset N_{OFFSET,CQI} of periodic CSI feedback are transferred to UE as a higher layer message (e.g., an RRC message) through a parameter called ‘cqi-pmi-ConfigIndex’ (i.e., I_{CQI/PMI}). A relationship between the parameter I_{CQI/PMI} and the periodicity and subframe offset is listed in Table 6 in case of FDD and in Table 7 in case of TDD.

TABLE 6

| | | Value |
|---|---|---|
| I_{CQI/PMI} | Value of N_{pd} | of N_{OFFSET,CQI} |
| 0 ≦ I_{CQI/PMI} ≦ 1 | 2 | I_{CQI/PMI} |
| 2 ≦ I_{CQI/PMI} ≦ 6 | 5 | I_{CQI/PMI}-2 |
| 7 ≦ I_{CQI/PMI} ≦ 16 | 10 | I_{CQI/PMI}-7 |
| 17 ≦ I_{CQI/PMI} ≦ 36 | 20 | I_{CQI/PMI}-17 |
| 37 ≦ I_{CQI/PMI} ≦ 76 | 40 | I_{CQI/PMI}-37 |
| 77 ≦ I_{CQI/PMI} ≦ 156 | 80 | I_{CQI/PMI}-77 |
| 157 ≦ I_{CQI/PMI} ≦ 316 | 160 | I_{CQI/PMI}-157 |
| I_{CQI/PMI} = 317 | Reserved | |
| 318 ≦ I_{CQI/PMI} ≦ 349 | 32 | I_{CQI/PMI}-318 |
| 350 ≦ I_{CQI/PMI} ≦ 413 | 64 | I_{CQI/PMI}-350 |
| 414 ≦ I_{CQI/PMI} ≦ 541 | 128 | I_{CQI/PMI}-414 |

| | |
|---|---|
| 542 ≦ I_{CQI/PMI} ≦ 1023 | Reserved |

TABLE 7

| | | Value |
|---|---|---|
| I_{CQI/PMI} | Value of N_{pd} | of N_{OFFSET,CQI} |
| I_{CQI/PMI} = 0 | 1 | I_{CQI/PMI} |
| 1 ≦ I_{CQI/PMI} ≦ 5 | 5 | I_{CQI/PMI}-1 |
| 6 ≦ I_{CQI/PMI} ≦ 15 | 10 | I_{CQI/PMI}-6 |
| 16 ≦ I_{CQI/PMI} ≦ 35 | 20 | I_{CQI/PMI}-16 |
| 36 ≦ I_{CQI/PMI} ≦ 75 | 40 | I_{CQI/PMI}-36 |
| 76 ≦ I_{CQI/PMI} ≦ 155 | 80 | I_{CQI/PMI}-76 |
| 156 ≦ I_{CQI/PMI} ≦ 315 | 160 | I_{CQI/PMI}-156 |

| | |
|---|---|
| 316 ≦ I_{CQI/PMI} ≦ 1023 | Reserved |

A periodic PUCCH reporting mode is listed in Table below.

TABLE 8

PMI Feedback Type

| | | No PMI | Single PMI |
|---|---|---|---|
| PUCCH CQI | Wideband | Mode1-0 | Mode1-1 |
| Feedback | (wideband CQI) | | |
| Type | UE selected | Mode2-0 | Mode2-1 |
| | (subband CQI) | | |

In the above-described periodic or aperiodic CSI feedback, UE have to measure the reference signal of a specific resource region in order to feed back CSI, for example, a CQI. Resources that have to be measured in order to generate the CQI are called CQI reference resources. A definition of conventional CQI reference resources is described below.

For example, let assume that UE feeds back CQI in a UL subframe n. In this case, a CQI reference resource is defined as a group of DL physical resource blocks corresponding to a frequency band which is related to a CQI value in the frequency domain and is defined as one DL subframe n-n_{CQI}_{_{—}}_{ref} in the time domain.

In periodic CQI feedback, n_{CQI}_{_{—}}_{ref} is the smallest value from among 4 or more values corresponding to a valid DL subframe. In aperiodic CQI feedback, n_{CQI}_{_{—}}_{ref} indicates a valid DL subframe including a UL DCI format including a relevant CQI request.

In aperiodic CQI feedback, if the DL subframe n-n_{CQI}_{_{—}}_{ref} is received after a subframe including a CQI request included in a random access response grant, n_{CQI}_{_{—}}_{ref} is 4, and the DL subframe n-n_{CQI}_{_{—}}_{ref} corresponds to a valid DL subframe.

A DL subframe is considered as a valid DL subframe to a UE if it meets the following conditions.

1. The DL subframe is configured for the UE, 2. Except for transmission mode 9, the DL subframe is not a Multicast-Broadcast Single Frequency Network (MBSFN) subframe, 3. The DL subframe does not contain a DwPTS field in case the length of DwPTS field is 7680T, and less (here, 307200Ts=10 ms), 4. the DL subframe should not correspond to a configured measurement gap for the UE.

If a valid DL subframe for CQI reference resources does not exist, CQI feedback is omitted in UL subframe n.

In the layer domain, CQI reference resources are defined by any RI and PMI value on which the CQI is conditioned.

In CQI reference resources, UE is operated under the following assumption in order to derive a CQI index.

1. In CQI reference resources, the first 3 OFDM symbols are occupied by a control signal.

2. In CQI reference resources, there is no resource element used by a Primary Synchronization Signal (PSS), a Secondary Synchronization Signal (SSS), or a Physical Broadcast Channel (PBCH).

3. In CQI reference resources, the CP length of a non-MBSFN subframe is assumed.

4. Redundancy version 0

Table below shows the transmission modes of a PDSCH assumed for CQI reference resources.

TABLE 9

| Transmission mode | Transmission Scheme of PDSCH |
|---|---|
| 1 | Single-antenna port, port 0 |
| 2 | Transmit diversity |
| 3 | Transmit diversity if an associated rank indicator |
| | is 1, otherwise large delay CDD |
| 4 | Closed-loop spatial multiplexing |
| 5 | Multi-user MIMO |
| 6 | Closed-loop spatial multiplexing with a single |
| | transmission layer |
| 7 | If the number of PBCH antenna ports is one, single- |
| | antenna port, port 0; otherwise transmit diversity |
| 8 | If UE is configured without PMI/RI reporting: if the |
| | number of PBCH antenna ports is one, single- |
| | antenna port, port 0; otherwise transmit |
| | diversity |
| | If UE is configured with PMI/RI reporting: |
| | closed-loop spatial multiplexing |
| 9 | Closed-loop spatial multiplexing with up to 8 layer |
| | transmission, ports 7-14 |

A transport mode 9 is closed-loop spatial multiplexing enabling a maximum of 8 layer transmissions, and it may use antenna ports 7-14.

In the transmission mode 9 and its feedback reporting mode, UE performs channel measurement for calculating CQI based on only a CSI-RS. In the remaining transmission modes and relevant reporting modes, UE performs channel measurement for calculating CQI based on a CRS.

A CQI index fed back by UE and its meanings are listed in Table below.

TABLE 10

| CQI INDEX | MODULATION | CODE RATE × 1024 | EFFICIENCY |
|---|---|---|---|
| 0 | Out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

As described above, in a conventional periodic CQI feedback or reporting method, a BS configures the periodicity N_{pd} of a periodic CQI feedback and a subframe offset N_{OFFSET,CQI} semi-statically by using a parameter called ‘cqi-pmi-ConfigIndex’ (i.e., T_{CQI/PMI}) through a higher layer signal. In response thereto, UE measures a CRS or a CSI-RS in CQI reference resources and sends a CQI through the PUCCH of an UL subframe configured by the parameter (i.e., I_{CQI/PMI}). In this case, as described above, the UE measures a physical RB group in the frequency domain and the reference signal of one DL subframe (a DL subframe n-n_{CQI}_{_{—}}_{ref}) in the time domain.

In a conventional aperiodic CQI feedback method, a BS triggers an aperiodic CQI feedback by sending an UL DCI format including a CQI request. In response thereto, UE sends an aperiodic CQI in an UL subframe scheduled by the UL DCI format. In this case, the UE measures a physical RB group in the frequency domain and the reference signal of a valid DL subframe including the UL DCI format including the CQI request in the time domain and generates an aperiodic CQI based on the measurement.

In the above-described period/aperiodic CQI feedbacks, resources, that is, the subject of measurement are called CQI reference resources.

Meanwhile, in a multi-node system, a plurality of nodes or a node group may be allocated to UE, and each node or each group may use a different reference signal. In this case, UE may have to measure a plurality of reference signals and report CSI (e.g., a CQI) for each of the reference signals.

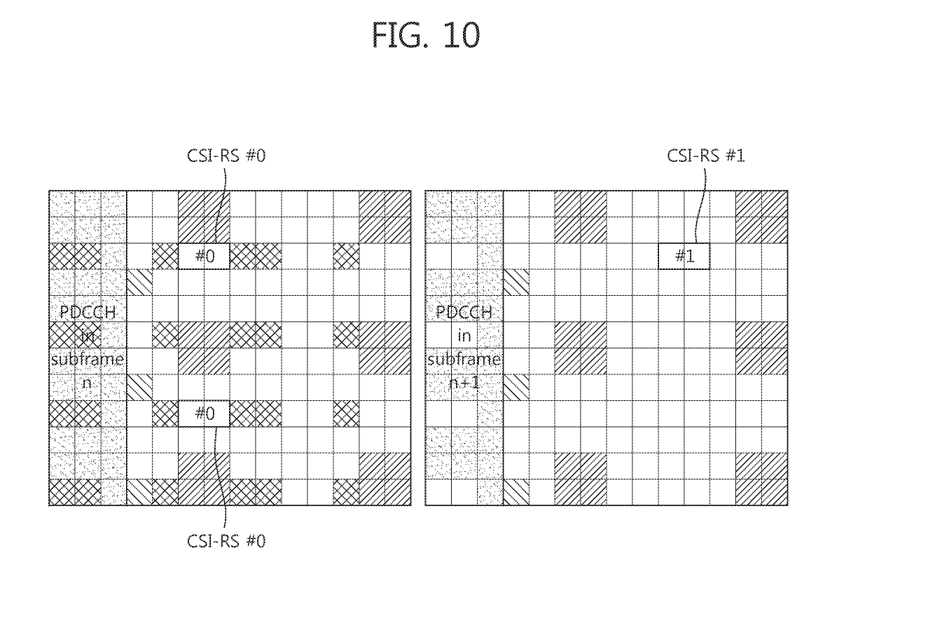

FIG. 10 illustrates a plurality of CSI-RSs that have to be measured by one UE.

Referring to FIG. 10, a CSI-RS #0 (indicated by #0) and a CSI-RS #1 (indicated by #1) may be configured for the UE. The CSI-RS #0 may be a CSI-RS transmitted by node #N, and the CSI-RS #1 may be a CSI-RS transmitted by a node #M.

The CSI-RS #0 and the CSI-RS #1 may have the same transmission periodicity. For example, the CSI-RS #0 may be transmitted in a subframe n+10m (m is 0 or a natural number). The CSI-RS #1 may be transmitted in a subframe n+1+10m. That is, the CSI-RS #0 and the CSI-RS #1 have the same transmission periodicity, but they may be two different CSI-RSs having different subframe offset values.

As shown in FIG. 10, CSI-RSs transmitted in different subframes may be configured for the same UE, but not limited thereto. That is, a plurality of CSI-RSs transmitted in the same subframe may be configured for the same UE.

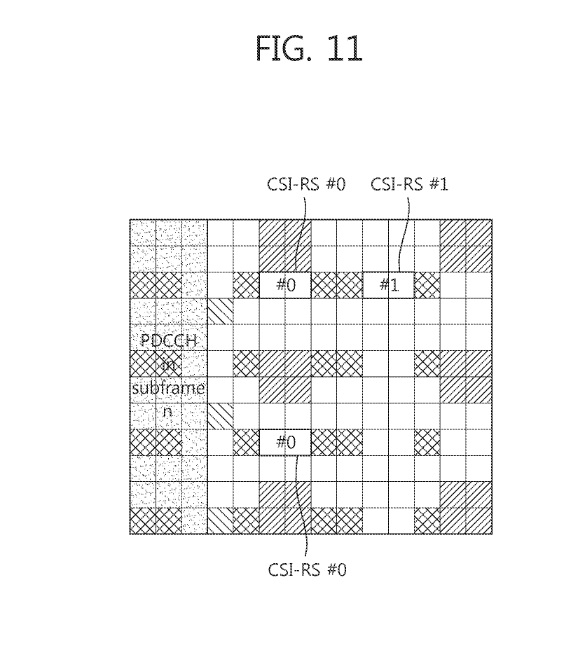

FIG. 11 shows an example in which a plurality of CSI-RSs transmitted in the same subframe is configured for the same UE.

Referring to FIG. 11, CSI-RS #0 and #1 are transmitted in a subframe n. The CSI-RS #0 may be a CSI-RS transmitted by a node #N, and the CSI-RS #1 may be a CSI-RS transmitted by a node #M.

As described above, if a plurality of CSI-RSs is configured for the same UE, how to transmit the CSI is problematic.

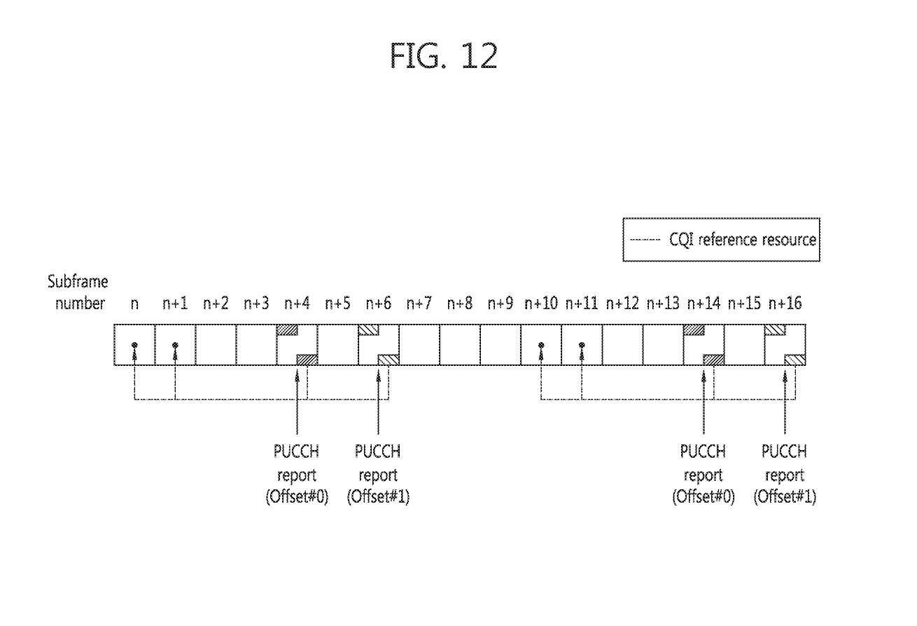

FIG. 12 illustrates a first embodiment of a periodic CSI transmission method performed by UE.

Referring to FIG. 12, two CSI-RSs transmitted in a subframe n+10k (k is 0 or a natural number) and a subframe n+1+10k may be allocated to the UE. It is assumed that the CSI-RS transmitted in the subframe n+10k is a CSI-RS #0 and the CSI-RS transmitted in the subframe n+1+10k is a CSI-RS #1.

A BS may configure the periodicity N_{pd} of a periodic CSI feedback and a plurality of subframe offsets N_{OFFSET,CQI,1} and N_{OFFSET,CQI,2} through, for example, a higher layer message, more particularly, a parameter called ‘cqi-pmi-ConfigIndex’ (i.e., I_{CQI/PMI}). The UE may feed back CSI through PUCCHs placed in the two subframes by using the periodicity of the periodic CSI feedback and the plurality of subframe offsets.

FIG. 12 shows an example in which 10 subframes are given to the periodicity of the periodic CSI feedback and the subframe offset values are 4 and 5.

If UE feeds back CSI as in the first embodiment, there is a limit to BS scheduling for PUCCHs to be used by the UE when CSI reference resources are specified according to a conventional definition.

If periodic CSI is sought to be fed back by using a PUCCH in a subframe n+4 in the state in which CSI-RSs have been configured as in FIG. 12, the CSI-RS of a subframe n has to be measured and CSI has to be generated based on the measurement. In order to feed back periodic CSI by using a PUCCH in any one of a subframe n+5 to a subframe n+13, the CSI-RS of a subframe n+1 has to be measured and CSI has to be generated based on the measurement. That is, the subframe n is used as CSI reference resources in the subframe n+4, and the subframe n+1 is used as CSI reference resources in the subframes n+5 to n+13. Accordingly, a CSI feedback for the CSI-RS #0 is possible only in the subframe n+4, and a CSI feedback for the CSI-RS #1 is possible only in the subframes n+5 to n+13. In accordance with a definition of conventional CSI reference resources, there is a limit to BS scheduling because the CSI feedback for the CSI-RS #0 is possible only in a subframe n+4+T (T is CSI feedback periodicity).

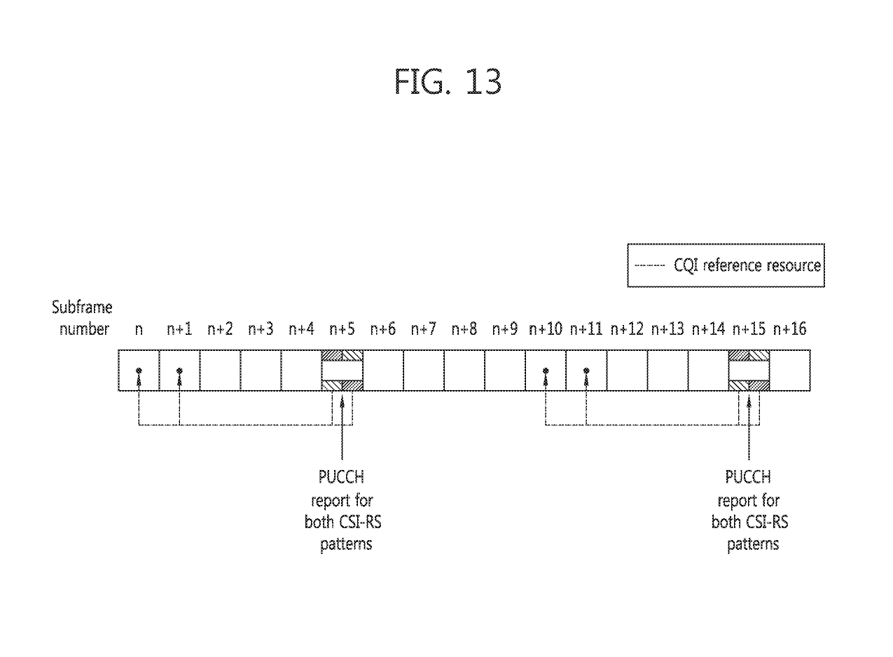

FIG. 13 illustrates a second embodiment of a periodic CSI transmission method performed by UE.

In FIG. 13, like in FIG. 12, two CSI-RSs transmitted in a subframe n+10k (k is 0 or a natural number) and a subframe n+1+10k may be allocated to the UE. It is assumed that the CSI-RS transmitted in the subframe n+10k is a CSI-RS #0 and the CSI-RS transmitted in the subframe n+1+10k is a CSI-RS #1. A BS may configure CSI about a plurality of CSI-RSs so that the CSI is transmitted through a plurality of PUCCHs within one UL subframe. That is, the BS may configure CSI about CSI-RSs transmitted in subframes n+10k and n+1+10k (k is 0 or a natural number) so that the CSI is fed back through 2 PUCCHs within a subframe n+5+10k.

If UE feeds back CSI as in the second embodiment, CSI reference resources cannot be specified according to a conventional definition.

It is assumed that the 2 PUCCHs of a subframe n+5 are a PUCCH #0 and a PUCCH #1. It is also assumed that CSI about a CSI-RS #0 is fed back in the PUCCH #0 and CSI about a CSI-RS #1 is fed back in the PUCCH #1. In accordance with a conventional definition of CSI reference resources, UE measures a reference signal in specific physical RBs of a subframe corresponding to a valid DL subframe, from among subframes prior to 4 subframes, and generates CSI based on the measurement.

In accordance with the conventional definition of CSI reference resources, CSI reference resources must become the same valid DL subframe for the PUCCH #0 and the PUCCH #1 transmitted in the same subframe. If the PUCCH #0 and the PUCCH #1 are transmitted in a subframe n+5, CSI reference resources must become a subframe n+1.

However, CSI desired by the BS is CSI about the CSI-RSs transmitted in the subframes n and n+1. Thus, the definition of CSI reference resources needs to be changed. CQI reference resources are described as an example of CSI reference resources.

In the existing definition of CQI reference resources, a valid DL subframe may be changed as follows.

I. First Example of a Definition of CQI Reference Resources.

In addition to the convention definition in which 1. the CQI reference resources are configured for UE as a DL subframe, 2. the CQI reference resources should not be an MBSFN subframe other than the transport mode 9, 3. the CQI reference resources should not include a DwPTS field when the length of the DwPTS field is 7680TS or less, and 4. the CQI reference resources should not correspond to a measurement gap configured to UE, a definition in which 5. in the transport mode 9, the CQI reference resources should be a subframe having a mapped CSI-RS and a CSI-RS pattern is mapped to a PUCCH, a PUSCH, or a CQI number is added. The CQI number indicates order (CQI#0, CQI#1, . . . ) of CQIs transmitted in one PUCCH when the CQIs are aligned and numbered.

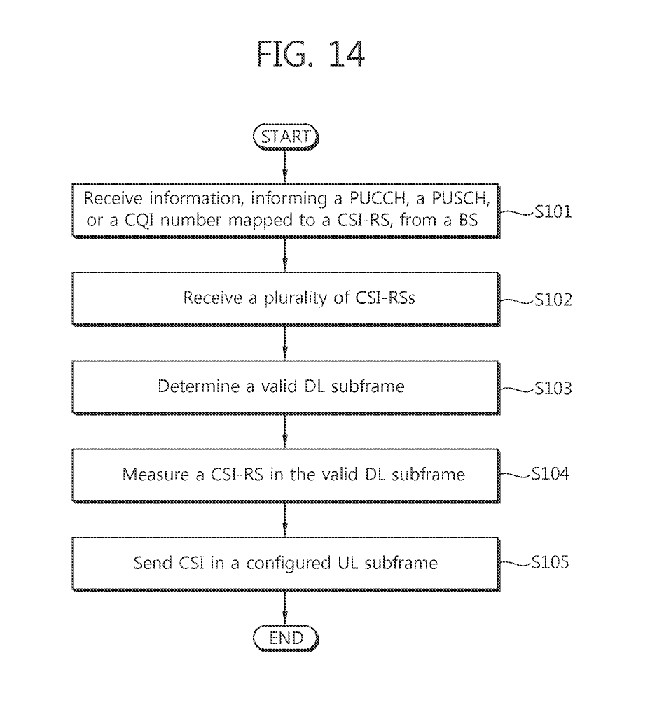

FIG. 14 shows an example of a CSI feedback method performed by UE when the first example of a definition of CQI reference resources is used.

The UE receives mapping information, informing a PUCCH, a PUSCH, or a CQI number mapped to a CSI-RS, from a BS (S101). The BS may include the mapping information in DCI transmitted through a PDCCH or may inform the mapping information through a higher layer message.

The UE receives a plurality of CSI-RSs (S102). The UE may receive a plurality of CSI-RSs transmitted by a plurality of nodes.

The UE determines a valid DL subframe based on the first example of a definition of CQI reference resources and the mapping information (S103) and measures a CSI-RS in the valid DL subframe (S104). That is, in order to send CSI through a PUCCH or a PUSCH, the UE determines a valid DL subframe mapped to the PUCCH or the PUSCH based on mapping information and measures the CSI-RS of the valid DL subframe.

The UE sends the CSI in a configured UL subframe (S105). The configured UL subframe is an UL subframe semi-statically configured in case of a periodic CSI feedback and is an UL subframe scheduled according to an UL DCI format in case of an aperiodic CSI feedback.

An example in which a BS provides mapping information to UE has been described above, but the present invention is not limited thereto. That is, the mapping information may be previously determined. In this case, the transmission and reception of the mapping information may be unnecessary.

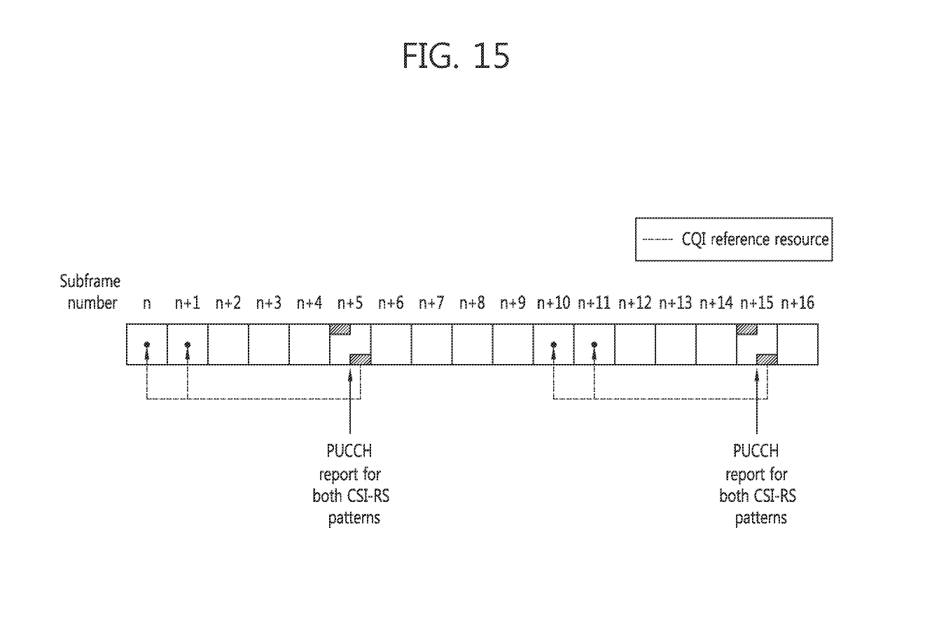

FIG. 15 shows a third embodiment of a periodic CSI transmission method performed by UE.

In FIG. 15, like in FIG. 12, two CSI-RSs transmitted in a subframe n+10k (k is 0 or a natural number) and a subframe n+1+10k may be allocated to the UE. A BS may configure CSI about a plurality of CSI-RSs so that the CSI is transmitted through one PUCCH within one UL subframe. That is, the BS may configure the CSI about the CSI-RSs transmitted in the subframes n+10k and n+1+10k (k is 0 or a natural number) so that the CSI is fed back through one PUCCH of the subframe n+5+10k.

If the UE feeds back the CSI as in the third embodiment, CSI reference resources cannot be defined according to a conventional definition.

Accordingly, a conventional definition of CSI reference resources may be changed as follows.

II. Second Example of a Definition of CQI Reference Resources.

That is, subframes on which each CSI-RS, that is, the subject of measurement, has been recently transmitted are defined as CSI reference resources. In this case, the CSI reference resources may be expanded to a plurality of subframes.

For example, CQI reference resources may be defined as N DL subframes in the time domain. The N DL subframes are N DL subframes ranging from a DL subframe n-n_{CQI-ref}−N+1 to a DL subframe n-n_{CQI-ref}.

N indicating the number of subframes of the CQI reference resources is identical with the number of DL subframes including a CSI-RS within CSI-RS transmission periodicity for the transport mode 9 and is 1 in other cases.

The number N of subframes of the CQI reference resources in the time domain may be defined as described above or a BS may set the number N to a value signalized to UE. The BS may inform the UE a value of the number N through DCI transmitted through a PDCCH or a higher layer message.

In the third embodiment, if the number of CQIs to be transmitted through a PUCCH is plural, a valid DL subframe for each CQI may be determined based on mapping information.

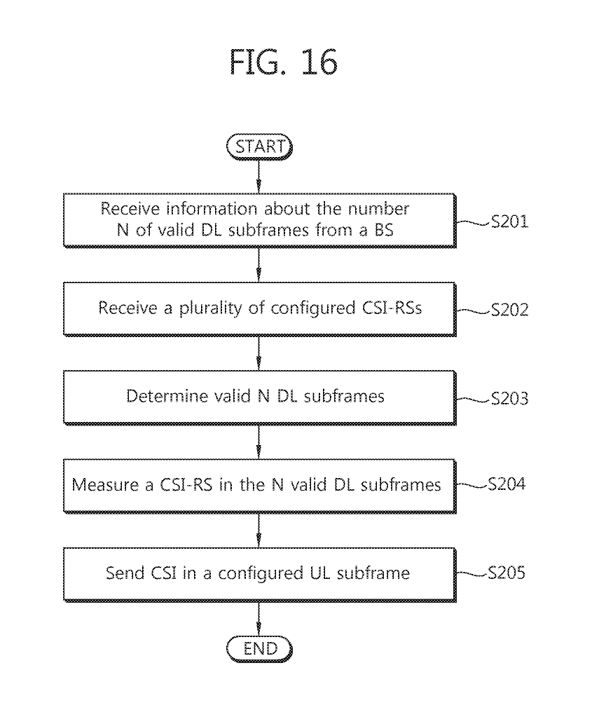

FIG. 16 shows an example of a CSI feedback method performed by UE when the second example of a definition of CQI reference resources is used.

The UE receives information about the number N of valid DL subframes, forming CQI reference resources, from a BS (S201). The BS may include mapping information in DCI transmitted through a PDCCH or inform the mapping information through a higher layer message.

The UE receives a plurality of configured CSI-RSs (S202). The UE may receive the plurality of CSI-RSs transmitted by a plurality of nodes.

The UE determines valid DL subframes based on the second example of a definition of CQI reference resources and the information about the number N (S203) and measures a CSI-RS in the N valid DL subframes based on the measurement (S204).

The UE sends CSI in a configured UL subframe (S205). The configured UL subframe is an UL subframe semi-statically configured in case of a periodic CSI feedback and is an UL subframe scheduled according to an UL DCI format in case of an aperiodic CSI feedback.

An example in which a BS provides information about the number N to UE has been described above, but the present invention is not limited thereto. That is, the information about the number N may be previously determined. In this case, the transmission and reception of the information about the number N may be unnecessary.

A PUCCH has been illustrated as being used as periodic CSI transmission in the above example, but the present invention is not limited thereto. There is a possibility that a periodic PUSCH feedback may be supported in the future LTE because of a limited amount of information that may be transmitted in a PUCCH. The periodic PUSCH feedback means that a BS configures PUSCH resources through which UE may perform a periodic CSI feedback and the UE performs the periodic CSI feedback by using the PUSCH resources. In this case, the PUCCH in the above example may be replaced with a PUSCH.

An aperiodic CSI feedback method is described below.

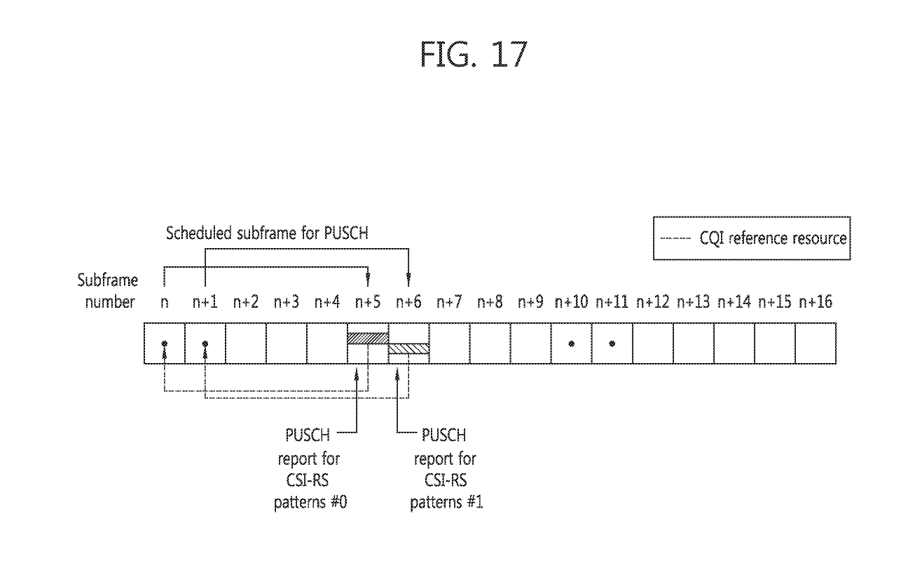

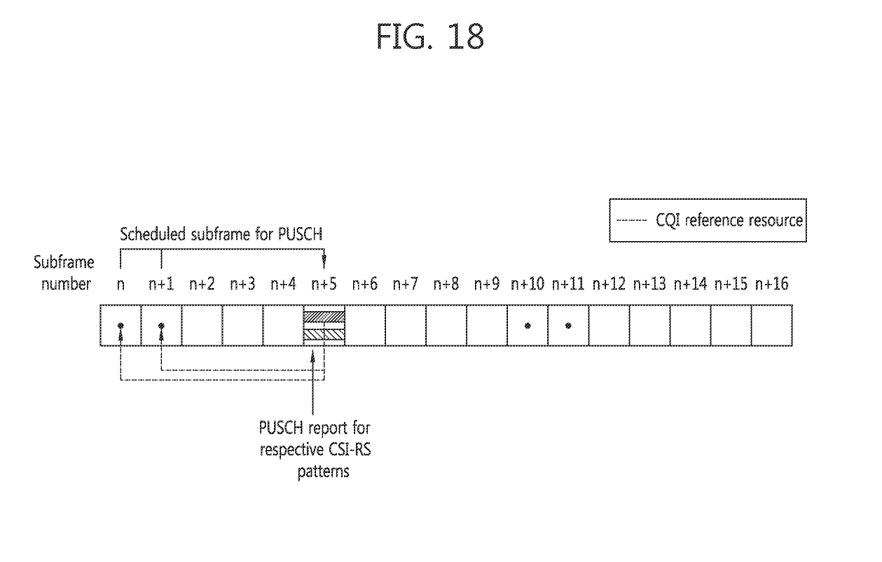

FIG. 17 shows a first embodiment of an aperiodic CSI transmission method performed by UE, and FIG. 18 shows a second embodiment of an aperiodic CSI transmission method performed by UE.

FIG. 17 shows an example in which UE measures CSI-RSs allocated to a plurality of subframes and then sends CSI through the PUSCHs of the plurality of subframes. FIG. 18 shows an example in which UE measures CSI-RSs allocated to a plurality of subframes and then sends CSI through the PUSCHs of one of the subframes.

The first embodiment and the second embodiment of the aperiodic CSI transmission method may be implemented according to a definition of conventional CSI reference resources.

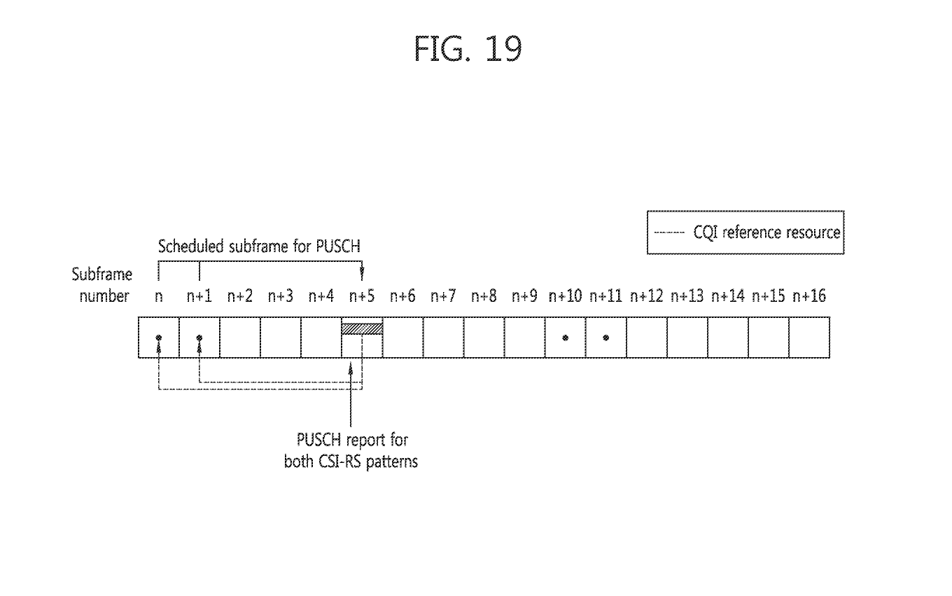

FIG. 19 shows a third embodiment of an aperiodic CSI transmission method performed by UE.

In accordance with the third embodiment of an aperiodic CSI transmission method, CSI about two CSI-RSs received in subframes n and n+1 is transmitted in the PUSCH of a subframe n+5. This method is not possible in the conventional definition of CSI reference resources. Accordingly, it is preferred that CQI reference resources be determined by using the second example of the definition of the CQI reference resources.

The second example of the definition of the CQI reference resources may be changed as follows.

III. Example of a Definition of CQI Reference Resources.

In the time domain, CQI reference resources may be defined as N DL subframe, that is, n-n_{CQI}_{_{—}}_{ref}(i) wherein i=0, . . . , N−1.

In a periodic CQI feedback, n_{CQI}_{_{—}}_{ref}(i) is a valid DL subframe having the smallest value from among 4 or higher values, but is not equal to n_{CQI}_{_{—}}_{ref}(j) when i differs from j.

In an aperiodic CQI feedback, n_{CQI}_{_{—}}_{ref}(i) is a valid DL subframe which includes an UL DCI format including a CQI request, but is not equal to n_{CQI}_{_{—}}_{ref}(j) when i differs from j.

In an aperiodic CQI feedback, if a DL subframe n-n_{CQI}_{_{—}}_{ref} is received after a subframe which includes a CQI request included in a random access response grant, n_{CQI}_{_{—}}_{ref}(0) is 4 and the DL subframe n-n_{CQI}_{_{—}}_{ref} corresponds to a valid DL subframe.

N indicating the number of CQI reference resources is identical with the number of subframes where a configured CSI-RS is placed within configured CSI-RS transmission periodicity in case of the transport mode 9 and is 1 in other cases.

Meanwhile, if CSI is fed back through a single PUSCH as in the third embodiment of the CSI transmission method, all subframes on which CSI-RSs are transmitted may be used as CSI reference resources, but only a subframe on which a specific one of the subframes on which the CSI-RSs are transmitted may be used as CSI reference resources.

For example, when a BS requests an aperiodic CSI feedback, the BS may request only a CSI feedback for a specific CSI-RS pattern. In this case, UE may use only a specific subframe on which a relevant CSI-RS pattern is transmitted as CSI reference resources.

The position of the specific subframe may be determined by using a method of adding a specific subframe offset to a DL subframe through which the aperiodic CSI feedback is requested or subtracting the specific subframe offset from the DL subframe. The subframe offset may be informed by using any one of the following methods.

(1). Method of using a CSI request field value.

(2). Method of including the subframe offset value in DCI and sending the DCI to UE.

(3). Method of directly informing the subframe offset through an RRC message.

The method of using a CSI request field value (1) may be applied to an example in which a new CSI request field that may designate that a BS may request a CSI feedback for what CSI-RS pattern from UE has been defined. That is, when a BS requests a CSI feedback for a specific CSI-RS pattern through a CSI request field, CSI reference resources may be determined based on a relevant CSI request field value.

In the methods (2) and (3), a BS explicitly informs a subframe offset value through DCI or an RRC message.

If a BS may request only an aperiodic CSI feedback for a specific CSI-RS pattern when requesting the aperiodic CSI feedback, a definition of CQI reference resources may be changed as follows.

IV. Fourth Example of a Definition of CQI Reference Resources.

It is assumed that UE feeds back a CQI in an UL subframe n. Here, CQI reference resources is defined a group of DL physical RBs corresponding to a frequency band that is related to a frequency domain CQI value and is defined as one DL subframe n-n_{CQI}_{_{—}}_{ref} in the time domain.

In a periodic CQI feedback, n_{CQI}_{_{—}}_{ref} is the smallest one of 4 or higher values corresponding to a valid DL subframe. In an aperiodic CQI feedback, n_{CQI}_{_{—}}_{ref} indicates a valid DL subframe to which or from which a subframe offset value n_{offset} determined by a CQI request field, a DCI field, or an RRC message has been added or subtracted on the basis of a valid DL subframe which includes an UL DCI format including a relevant CQI request.

In an aperiodic CQI feedback, if a DL subframe n-n_{CQI}_{_{—}}_{ref} is received after a subframe including a CQI request included in a random access response grant, n_{CQI}_{_{—}}_{ref} is 4, and the DL subframe n-n_{CQI}_{_{—}}_{ref} corresponds to a valid DL subframe.

A definition of the valid DL subframe is the same as a conventional definition.

The present invention has been described by taking a multi-ode system as an example in order to help understanding of the present invention, but the present invention is not limited thereto. That is, the present invention may be used when a multi-CSI-RS configuration is applied in a specific system. Furthermore, a CQI has been chiefly described as an example of CSI, but an RI, a PMI, etc. may be used as an example of CSI.

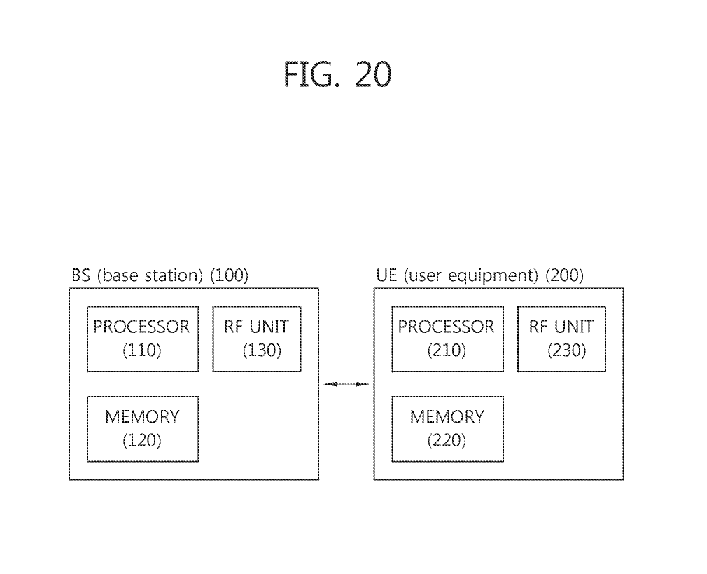

FIG. 20 is a block diagram showing a BS and UE.

The BS 100 includes a processor 110, memory 120, and a Radio Frequency (RF) unit 130. The processor 110 implements the proposed functions, processes and/or methods. The processor 110 may send mapping information that informs UE of a PUCCH, a PUSCH, or a CQI number mapped to a reference signal and send a plurality of reference signals through a plurality of nodes. In some embodiments, the BS 100 may send information about the number N of valid DL subframes forming CSI reference resources. The processor 110 may receive CSI fed back by UE and use the CSI in scheduling. The memory 120 is coupled to the processor 110 and is configured to store various pieces of information necessary to drive the processor 110. The RF unit 130 is coupled to the processor 110 and is configured to send and/receive radios signals. The RF unit 130 may be formed of a plurality of nodes coupled to the BS 100 in a wired manner.

The UE 200 includes a processor 210, memory 220, and an RF unit 230. The processor 210 performs the above-described functions and methods. For example, the processor 210 may receive mapping information, informing a PUCCH, a PUSCH, or a CQI number mapped to a reference signal through a higher layer signal, such as an RRC message, or DCI, or information about the number B of valid DL subframes forming CSI reference resources from a BS. The pieces of information may be applied by changing a conventional definition of CSI reference resources according to an embodiment of the present invention. Furthermore, the processor 210 receives a plurality of reference signals from allocated nodes, measures each of the plurality of reference signals, and generates CSI based on the measurement. Next, the processor 210 feeds back the CSI about each of the plurality of reference signals periodically or aperiodically. The memory 220 is coupled to the processor 210 and is configured to store various pieces of information necessary to drive the processor 210. The RF unit 230 is coupled to the processor 210 and is configured to send and/receive radios signals.

The processor 110, 210 may include Application-Specific Integrated Circuits (ASICs), other chipsets, logic circuits, data processors and/or a converter for mutually converting baseband signals and radio signals. The memory 120, 220 may include Read-Only Memory (ROM), Random Access Memory (RAM), flash memory, memory cards, storage media and/or other storage devices. The RF unit 130, 230 may include one or more antennas for transmitting and/or receiving radio signals. When the above-described embodiment is implemented in software, the above-described scheme may be implemented using a module (process or function) that performs the above function. The module may be stored in the memory 120, 220 and executed by the processor 110, 210. The memory 120, 220 may be placed inside or outside the processor 110, 210 and connected to the processor 110, 210 using a variety of well-known means

The present invention may be implemented using hardware, software, or a combination of them. In hardware implementations, the present invention may be implemented using Application Specific Integrated Circuits (ASICs), Digital Signal Processors (DSPs), Programmable Logic Devices (PLDs), Field Programmable Gate Arrays (FPGAs), processors, controllers, microprocessors, other electronic units, or a combination of them, which are designed to perform the above function. In software implementations, the present invention may be implemented using a module performing the above function. The software may be stored in the memory and executed by the processor. The memory or the processor may adopt various means well known to those skilled in the art.

Although the some embodiments of the present invention have been described above, a person having ordinary skill in the art will appreciate that the present invention may be modified and changed in various ways without departing from the technical spirit and scope of the present invention. Accordingly, the present invention is not limited to the embodiments and the present invention may be said to include all embodiments within the scope of the claims below.

1. A method of user equipment transmitting channel state information, the method comprising:
receiving mapping information informing an uplink (UL) channel mapped to a reference signal;
determining a valid downlink (DL) subframe based on the mapping information;
measuring the reference signal in the valid DL subframe; and
transmitting Channel State Information (CSI), generated based on the measurement, in a configured UL subframe,
wherein the UL channel is placed in the configured UL subframe, and the valid DL subframe is a DL subframe including the reference signal mapped to the UL channel.

2. The method of claim 1, wherein the UL channel is a Physical Uplink Control CHannel (PUCCH) or a Physical Uplink Shared CHannel (PUSCH).

3. The method of claim 2, wherein the CSI is periodically transmitted when the UL channel is the PUCCH.

4. The method of claim 2, wherein the CSI is aperiodically transmitted when the UL channel is the PUSCH.

5. The method of claim 1, wherein the reference signal includes a plurality of reference signals placed in a plurality of DL subframes.

6. The method of claim 5, wherein the configured UL subframe comprises a plurality of UL subframes having different subframe offset values with respect to each of the plurality of DL subframes.

7. The method of claim 5, wherein the configured UL subframe is one UL subframe for the plurality of DL subframes.

8. A method of user equipment transmitting channel state information, comprising:
receiving information about a number N of valid downlink (DL) subframes forming Channel State Information (CSI) reference resources;
determining N valid DL subframes based on the information about the number N;
measuring a reference signal in the N valid DL subframes; and
transmitting CSI, generated based on the measurement, in a configured uplink (UL) subframe,
wherein the N valid DL subframes are DL subframes on which a reference signal, which is a subject of measurement, is received most recently with respect to the configured UL subframe.

9. The method of claim 8, wherein the information about the number N is received Downlink Control Information (DCI) or a Radio Resource Control (RRC) message.

10. The method of claim 8, wherein the number N is equal to a number of DL subframes including reference signals needed to be measured by the user equipment.

11. User equipment, comprising:
a Radio Frequency (RF) unit configured to transmit and receive radio signals; and
a processor coupled to the RF unit,
wherein the processor receives mapping information informing an uplink (UL) channel mapped to a reference signal, determines a valid downlink (DL) subframe based on the mapping information, measures the reference signal in the valid DL subframe, and transmits Channel State Information (CSI), generated based on the measurement, in a configured UL subframe,
the UL channel is placed in the configured UL subframe, and
the valid DL subframe is a DL subframe including the reference signal mapped to the UL channel.

12. User equipment, comprising:
a Radio Frequency (RF) unit configured to transmit and receive radio signals; and
a processor coupled to the RF unit,
wherein the processor receives information about a number N of valid downlink (DL) subframes forming Channel State Information (CSI) reference resources, determines N valid DL subframes based on the information about the number N, measures a reference signal in the N valid DL subframes, and transmits CSI, generated based on the measurement, in a configured uplink (UL) subframe,
wherein the N valid DL subframes are DL subframes on which a reference signal, which is a subject of measurement, is received most recently with respect to the configured UL subframe.
